(19) United States
(12) Patent Application Publication
(10) Pub. No.: US 2007/0201819 A1
(43) Pub. Date: Aug. 30, 2007

(54) Apparatus and method for variable speed playback of digital broadcasting stream

(75) Inventors: Ki-Yeon Sung, Anyang-si (KR); Young-Seop Han, Suwon-si (KR); Young-Jip Kim, Suwon-si (KR); Kyung-Tack Kwon, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/704,693

(22) Filed: Feb. 9, 2007

(30) Foreign Application Priority Data
Feb. 9, 2006 (KR) 10-2006-0012595

(51) Int. Cl. H04N 5/91

(52) U.S. Cl. 386/68

(57) ABSTRACT

An apparatus and a method for controlling high-speed variable speed playback of digital broadcasting streams in a digital broadcasting receiver are disclosed that include a frame information table including a position information value of an I-frame stored in advance when digital broadcasting streams are recorded, and frames are scanned by means of the position information value in the frame information table when a variable speed playback mode is executed, so that the scanned frames can be stably provided to a decoder regardless of speed.

### PRIORITY

This application claims priority to an application entitled “Apparatus And Method For Variable Speed Playback Of Digital Broadcasting Stream” filed in the Korean Intellectual Property Office on Feb. 9, 2006 and assigned Ser. No. 2006-12595, the contents of which are hereby incorporated by reference.

### BACKGROUND OF THE INVENTION

1. Field of the Invention

The present invention relates to an apparatus and a method for reproducing digital broadcasting streams, and more particularly to an apparatus and a method for controlling high-speed variable speed playback of digital broadcasting streams in a digital broadcasting receiver.

2. Description of the Related Art

With the recent development of digital technology such as digital image compression and digital modulation/demodulation, standardization and commercialization for digital broadcasting have rapidly progressed. Even in conventional terrestrial, satellite and cable broadcasting, digitization based on a Moving Picture Experts Group (MPEG) has progressed. Further, with the development of digital image/voice compression technology and digital transmission technology, the digital broadcasting as described above can provide a higher quality broadcasting service as compared to an analog broadcasting service. Specifically, digital broadcasting can multiplex and transmit a plurality of broadcasting programs in the same bandwidth, and can considerably improve interoperability with digital communication media, digital storage media, etc. In digital broadcasting, a plurality of broadcasting programs encoded based on an MPEG format are multiplexed and are then transmitted in the form of Transport Streams (TSs). Further, the TSs are received in a digital broadcasting receiver, and information relating to a plurality of broadcasting programs included in the TSs is demultiplexed and extracted.

The digital broadcasting receiver provides a user with the extracted information, thereby allowing the user to select a desired broadcasting program. Herein, the digital broadcasting receiver demultiplexes video, audio and data streams corresponding to the selected program. Further, the digital broadcasting receiver restores demultiplexed streams into the original audio and video signals by means of a decoder provided therein, and outputs the restored signals to an Audio/Video (A/V) output device.

Nowadays, a digital broadcasting receiver has a high capacity hard disk therein, and stores MPEG streams of image and voice data of broadcasting programs transmitted to an A/V output device in the hard disk in the form of streams before restoration, or stores image and voice signals of broadcasting programs in the hard disk in the form of streams decoded again with an MPEG. Further, the digital broadcasting receiver has a Personal Video Recording (PVR) function capable of reproducing and outputting the broadcasting programs stored in the hard disk at a user's request.

A user stores digital broadcasting streams by means of such a PVR function. Further, while watching stored digital broadcasting, the user scans digital broadcasting programs, which are stored in the hard disk of the digital broadcasting receiver having the PVR function, from a current position of the displayed digital broadcasting to a specific position desired by the user, and plays the scanned digital broadcasting program at various speeds. That is, the user presses a rewind key or a fast forward key in order to watch a desired broadcast scene, allowing the user to shift to a frame position for outputting the desired broadcast scene. Hereinafter, a mode for shifting to the desired broadcast scene at a high speed and reproducing the corresponding broadcasting will be referred to as a high-speed variable speed playback mode. Such a high-speed variable speed playback mode may be classified as a backward variable speed playback mode and a forward variable speed playback mode.

Hereinafter, an internal construction of a general apparatus for executing a high-speed variable speed playback mode of digital broadcasting streams will be described with reference to FIG. 1.

If digital broadcasting streams are received in a digital broadcasting receiver 102 as a broadcasting service mode is executed, a controller 100 demultiplexes the broadcasting streams through a demultiplexer 106 within an MPEG decoder 104, divides audio/video data from catalog information, and stores the audio/video data and the catalog information in both an audio/video data storage area 114 and a catalog information storage area 116 within a storage unit (HDD) 112, respectively. If input for reproducing the stored broadcasting streams is received from a user, the controller 100 reads the corresponding broadcasting streams from the storage unit 112, and controls signals decoded through a decoder 108 to be displayed through a display unit 110. Herein, if the high-speed variable speed playback mode is executed during PVR file playback, the controller 100 sets only an I-frame to be reproduced in a broadcasting play mode, opens the catalog file stored in the storage unit 112, and extracts position information of I-frames to be provided to the decoder 108 while scanning the catalog file in real time. Then, the controller 100 reads A/V data between a corresponding I-frame and a subsequent I-frame from the position information of the extracted I-frames, provides the read A/V data to a decoding buffer, and outputs data, which are received from a buffer, to the display unit 110 through the decoder 108. While the high-speed variable speed playback mode is executed as described above, if a file playback speed increases, the high-speed variable speed playback mode is accomplished in such a manner that intervals between supplied I-frames are lengthened and predetermined intervals are skipped over.

When a user selects a desired frame in the playback mode as described above, when the digital broadcasting receiver directly scans the catalog file, no problem occurs because the number of skipped frames is reduced after intervals between I-frames are lengthened, when performed at a low speed. However, at a higher speed, the number of frames skipped between the I-frames increases. Further, when the high-speed variable speed playback mode is executed as described above, time required for scanning the I-frames may also increase because the number of frames skipped between the I-frames increases. That is, an I-frame scanning speed may become slower than a decoding speed. Therefore, underflow may occur, in which data are not smoothly supplied. When the underflow occurs as described above, broadcasting streams may not be normally decoded. Therefore, broadcasting may not be normally displayed on a screen.

As described above, when the high-speed variable speed playback mode is executed in the digital broadcasting receiver, frame scanning time changes according to speeds. Further, the number of frames, which must be scanned within a short time, increases in a higher speed, and thus frame scanning time also increases. Therefore, frames are not provided to a decoder in a stable manner, so that broadcasting displayed on a screen may be interrupted.

### SUMMARY OF THE INVENTION

Accordingly, the present invention has been made to solve the above-mentioned problems occurring in conventional systems, and it is an object of the present invention to provide an apparatus and a method for variable speed playback of digital broadcasting streams, in which frame scanning time can be constantly maintained regardless of speeds when a variable speed playback mode is executed.

It is another object of the present invention to provide an apparatus and a method for variable speed playback of digital broadcasting streams, in which only minimum frame data to be displayed on a screen are selectively provided to a decoder for efficient decoding when a high-speed variable speed playback mode is executed, so that output image quality can be improved.

In accordance with one aspect of the present invention, there is provided an apparatus for variable speed playback of digital broadcasting streams, the apparatus including a digital broadcasting reception unit for receiving digital broadcasting streams; a demultiplexer for demultiplexing the received digital broadcasting streams, thereby dividing audio/video data from catalog information; a frame information extractor for extracting position information of a specific frame from the catalog information output from the demultiplexer; a storage unit for storing a frame information table including the audio/video data and the extracted position information of the specific frame; and a controller for extracting the position information of the specific frame through the frame information extractor according to a digital broadcasting data record request, and storing the frame information table in the storage unit.

In the apparatus, if a high-speed variable speed playback mode request exists, the controller checks the position information of the specific frame in the frame information table according to a selected speed unit, reads audio/video data corresponding to a position of the specific frame, and outputs the audio/video data to a screen.

In the apparatus, if the high-speed variable speed playback mode request exists, the controller checks the selected speed unit, checks the increment and decrement interval of the I-frame index according to the selected speed unit, reads audio/video data stored in a predetermined position of the storage unit according to position values of the I-frame which must be output based on the checked increment and decrement interval, and outputs the audio/video data to the screen.

In accordance with another aspect of the present invention, there is provided a method for variable speed playback of digital broadcasting streams, the method including demultiplexing received digital broadcasting streams according to a digital broadcasting data record request, thereby dividing audio/video data from catalog information; extracting position information of a specific frame from the catalog information; and storing a frame information table including the audio/video data and the extracted position information of the specific frame.

The method further includes, if a high-speed variable speed playback mode request exists, checking the position information of the specific frame in the frame information table according to a selected speed unit; and reading audio/video data corresponding to a position of the specific frame, and outputting the audio/video data to a screen.

The method also includes if the high-speed variable speed playback mode request exists, checking the selected speed unit; checking the increment and decrement interval of the I-frame index according to the selected speed unit; and reading audio/video data stored in a corresponding position according to position values of the I-frame which must be output based on the checked increment and decrement interval, and outputting the audio/video data to the screen.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the general internal construction of an apparatus for executing a high-speed variable speed playback mode of digital broadcasting streams;

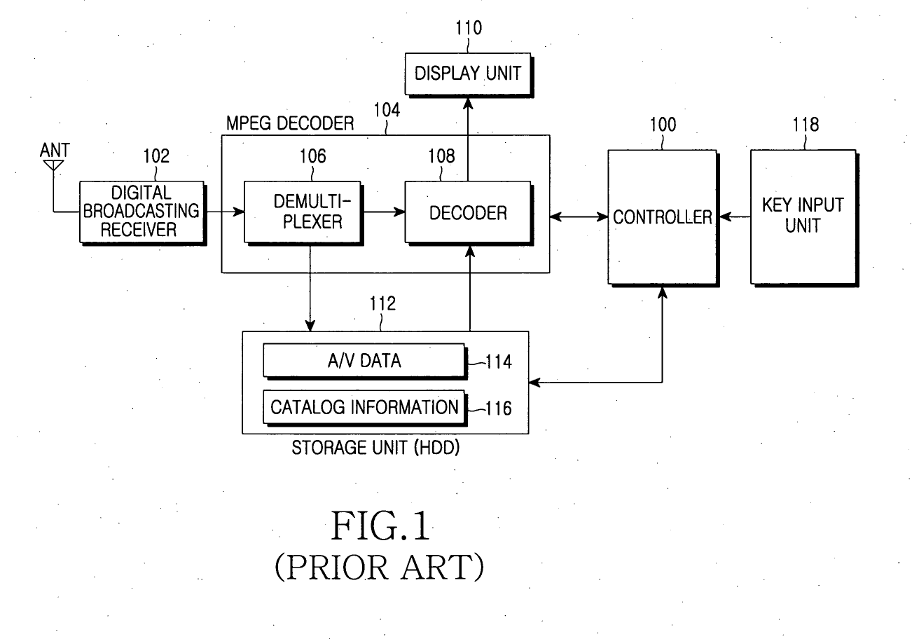

FIG. 2 is a block diagram illustrating the internal construction of an apparatus for executing a high-speed variable speed playback mode of digital broadcasting streams according to the present invention;

FIG. 3 is a diagram illustrating a frame information table used a high-speed variable speed playback mode of digital broadcasting streams is executed according to the present invention;

FIG. 4 is a flow diagram illustrating a process for generating a frame information table for separately storing I-frame position information when digital broadcasting streams are recorded according the present invention; and

FIG. 5 is a flow diagram illustrating a process for executing a high-speed variable speed playback mode when recorded digital broadcasting is reproduced according to the present invention.

### DETAILED DESCRIPTION OF THE PREFERRED EMBODIMENT

A preferred embodiment of the present invention will be described in detail herein below with reference to the accompanying drawings. In the following description, a detailed description of known functions and configurations incorporated herein will be omitted when it may obscure the subject matter of the present invention.

Generally, an MPEG decoder provides a forward speed function in order to increase its decoding speed. However, there is a limitation in a speed. In the case of a high speed during fast forward, a method for skipping over frames of predetermined intervals is applied, so that a high-speed variable speed playback mode is accomplished. Also, in the case of a backward speed function, a method for skipping over frames of predetermined intervals is applied to all speeds, so that a high-speed variable speed playback mode is accomplished. Accordingly, it is necessary to provide a method for exactly referring to the position of an I-frame having complete frame information in an MPEG file structure comprised of I-P-B frames. To this end, a method using catalog information is employed.

According to the present invention, when digital broadcasting streams received in the form of transport streams are recorded utilizing a PVR function, only information necessary for high-speed variable speed playback is extracted from catalog information, and is stored together with A/V data. That is, when the digital broadcasting streams are recorded, the start and end positions of an I-frame are extracted from the catalog information, are formed as a frame information table, and then the frame information table is stored in advance. Accordingly, when a high-speed variable speed playback mode is selected, a PVR file can be quickly scanned by reference to the previously stored I-frame position information.

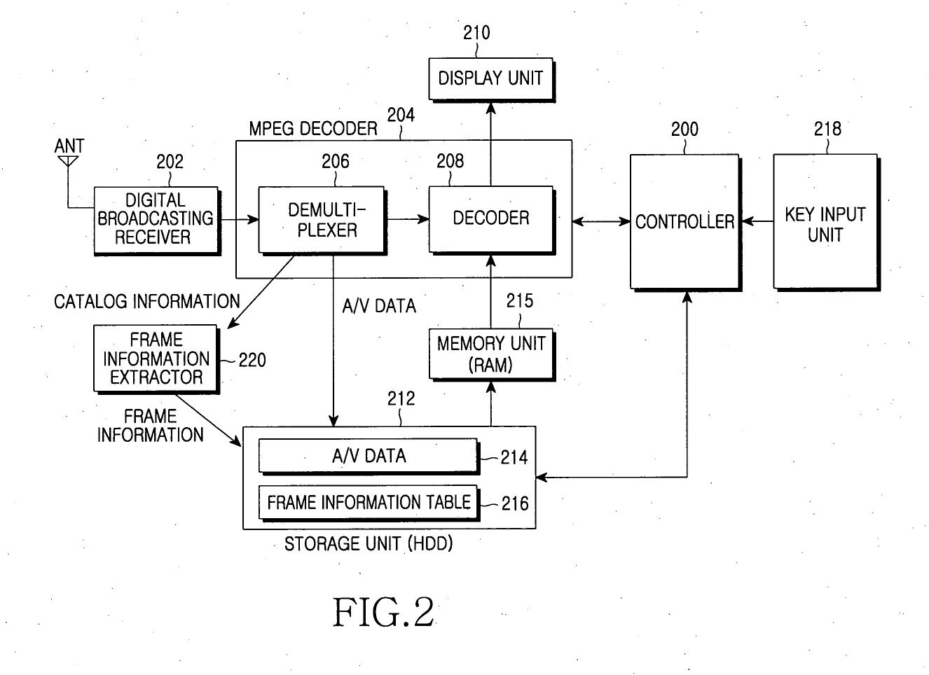

Hereinafter, an operation for executing a high-speed variable speed playback mode according to the present invention will be described with reference to FIG. 2.

The controller 200 of a digital broadcasting receiver controls overall operations for a broadcasting service. Specifically, in the present invention, when broadcasting streams are recorded, the controller 200 forms a frame information table in advance, which includes information necessary for executing the high-speed variable speed playback mode, and stores the frame information table. Further, when the high-speed variable speed playback mode is executed, the previously stored frame information table is used.

Hereinafter, the afore-mentioned operation will be described in detail.

If a broadcasting stream record request is received from a user through a key input unit 218, the controller 200 outputs the digital broadcasting streams, which are received in a digital broadcasting receiver 202, to a demultiplexer 206 within an MPEG decoder 204. The demultiplexer 206 demultiplexes the broadcasting streams, thereby dividing audio/video data from catalog information. Then, the controller 200 stores the audio/video data in an audio/video data storage area 214 within a storage unit HDD 212. Further, the controller 200 controls the catalog information to be output to a frame information extractor 220. The frame information extractor 220 extracts the start and end positions of an I-frame from the input catalog information, forms a frame information table by reference to the extracted start and end positions of the I-frame, and stores the frame information table in the storage unit 212.

That is, when a broadcasting transport stream file is decoded, element IDs are extracted. The element IDs include a video sequence header, a video sequence extension, a video sequence display extension, a group of pictures, a picture header, a picture coding extension, a picture quant extension, a video sequence quant matrix extension, etc. In order to execute the high-speed variable speed playback mode, it is necessary to identify the start and end positions of the I-frame. Accordingly, each position information of I, P and B frames is checked with reference to the picture header. Herein, only the start and end positions of the I-frame are extracted so that information of a desired frame can be quickly retrieved, an index is added to the I-frame, the start and end position values of the corresponding I-frame are stored in the form of a frame information table.

Table 1 below shows the data structure of each frame information constituting the frame information table as described above.

TABLE 1

```
typedef struct tag_USER_FRAME_INFO
{
  unsigned int  FrameStartCount;
  unsigned int  FrameEndCount;
} USER_FRAME_INFO,
*P_USER_FRAME_INFO;
```

Referring to table 1, the “FrameEndCount” represents an order of a packet at which a frame to be supplied to the decoder 208 starts, and the “FrameEndCount” represents an order of a packet at which the frame ends. Since an MPEG-TS file is formed in the unit of packets of 188 bytes, an actual offset value within the file is obtained by multiplying the count value by 188. Such frame information is arranged consecutively, so that the frame information table is formed. The frame information table is stored as a separate file together with each TS-AV file, and is used when the variable speed playback mode is executed.

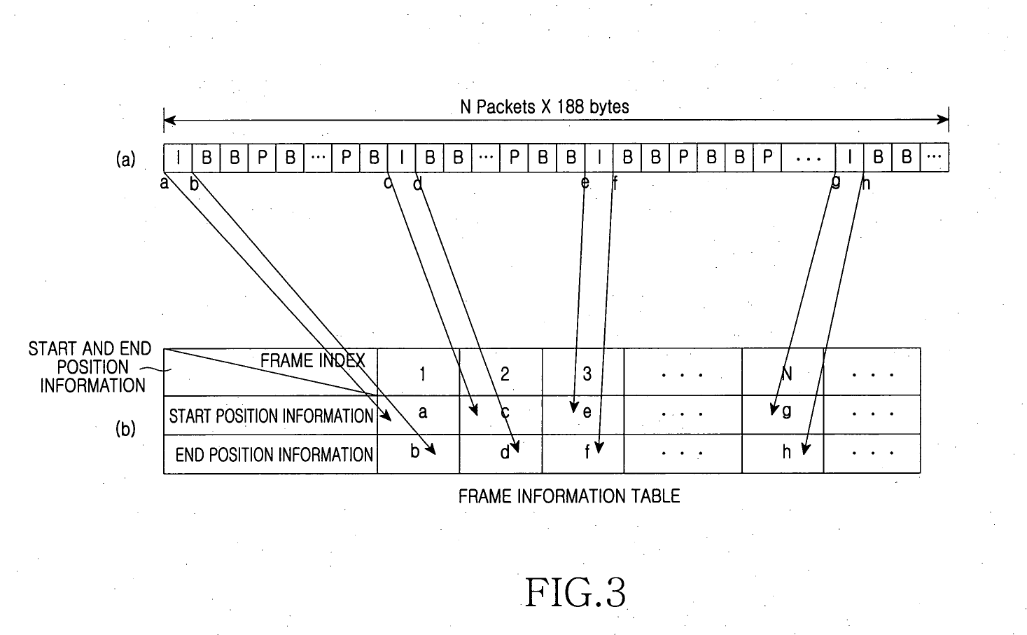

Hereinafter, an operation for forming a frame information table including the start and end positions of an I-frame from a received transport frame will be described with reference to FIG. 3.

In a transport frame including of I, P and B frames, the start and end offset values of the first I-frame are “a” and “b”, respectively. Then, 1 is given as a frame index value for the first I-frame, “a” is stored as a start position information value for the first I-frame, and “b” is stored as an end position information value for the first I-frame. Likewise, the start and end offset values of the second I-frame are “c” and “d”, respectively. Then, 2 is given as a frame index value for the second I-frame, “c” is stored as a start position information value for the second I-frame, and “d” is stored as an end position information value for the second I-frame. Herein, it is most ideal to set the end locations of each I-frame in the frame information table to have only available I-frame data in order to obtain maximum decoding performance. However, buffer underflow may occur due to system performance. Accordingly, a predetermined number of B-frames subsequent to the I-frame are allowed to be included in the end location, so that buffer underflow can be prevented from occurring.

Hereinafter, operation of the controller 200 will be described when a request for executing the high-speed variable speed playback mode is received when the frame information table for execution of the high-speed variable speed playback mode is stored in advance.

If request signals for reproducing stored broadcasting streams are received through the key input unit 218, the controller 200 reads corresponding A/V data utilizing the start and end position information of the I-frames in the frame information table stored in the storage unit 212, supplies the read A/V data to a decoding buffer, and controls data from the buffer to be output to the display unit 210 through the decoder 208. Herein, the controller 200 stores the frame information table generated when broadcasting streams are recorded in the storage unit 212, shifts the frame information table stored in the storage unit 212 to a memory unit 215 when the stored broadcasting streams are reproduced, and reads corresponding A/V data utilizing the position information of the frame information table stored in the memory unit 215.

Herein, the controller 200 checks an increment and decrement interval of a preset I-frame index according to speed units, and reads A/V data corresponding to the I-frame. For example, in the case of 12×-speed, the controller 200 sets an increment and decrement interval of a frame index to 1. In the case of 24×-speed, the controller 200 sets the increment and decrement interval to 2. In the case of 48×-speed, the controller 200 sets the increment and decrement interval to 4. Then, the controller 200 stores the set increment and decrement interval in the storage unit 212 in advance. When the high-speed variable speed playback mode is executed by a user, if the 12×-speed is selected, the controller 200 has only to read corresponding A/V data in a sequence of the frame indices 1, 2, . . . , N+1 (N=0, 1, 2, . . .) stored in the frame information table. Further, when the high-speed variable speed playback mode is executed by a user, if the 48×-speed is selected, the controller 200 has only to read corresponding A/V data in a sequence of the frame indices 1, 5, 9, . . . , 4N+1 (N=0, 1, 2, . . .) stored in the frame information table. According to the present invention, a speed changes only with the increment and decrement interval of an index, so that an infinite speed can be theoretically accomplished because the speed has no relation to performance.

The display unit 210 outputs various display data generated in the digital broadcasting receiver. It is preferred that the display unit 210 is constructed by a Liquid Crystal Display (LCD), etc., which can sufficiently support the resolution of a moving picture output from the digital broadcasting receiver. When the LCD has a touch screen function, the display unit 210 may also operate as an input unit.

The key input unit 218 receives user operation signals including key input, voice input, etc., and transfers the user operation signals to the controller 200.

The storage unit 212 may be realized by a Hard Disk Drive (HDD), and stores various information necessary for operation control of the digital broadcasting receiver according to the embodiment of the present invention. The storage unit 212 stores the frame information table including the A/V data and the position information of the I-frame in the transport frame, and information about the increment and decrement interval of the I-frame index according to speed units.

The memory unit 215 may be realized by a Random Access Memory (RAM), reads the frame information table stored in the storage unit 212 under the control of the controller 200, and stores the read frame information table according to the embodiment of the present invention.

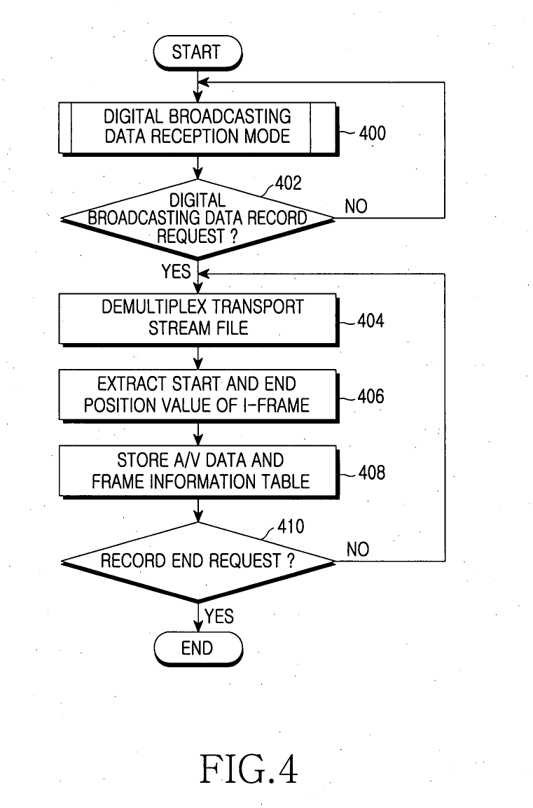

Hereinafter, a process for generating the frame information table, which separately stores I-frame position information when digital broadcasting streams are recorded in the digital broadcasting receiver having the construction of FIG. 2, will be described with reference to FIG. 4.

In step 402, the controller 200 determines if a digital broadcasting data record request exists when the digital broadcasting receiver is in a digital broadcasting data reception mode in step 400. If the digital broadcasting data record request exists, the controller 200 demultiplexes a transport stream file in step 404, and extracts the start and end position values of I-frames in step 406. In step 408, the controller 200 stores a frame information table, which includes A/V data and the extracted start and end position values of the I-frames, in the storage unit 212. If a record end request exists in step 410, the process ends. Otherwise, steps 404, 406, 408 and 410 are repeated. That is, the frame information table for separately storing the I-frame position information is generated and is stored in the storage unit 212.

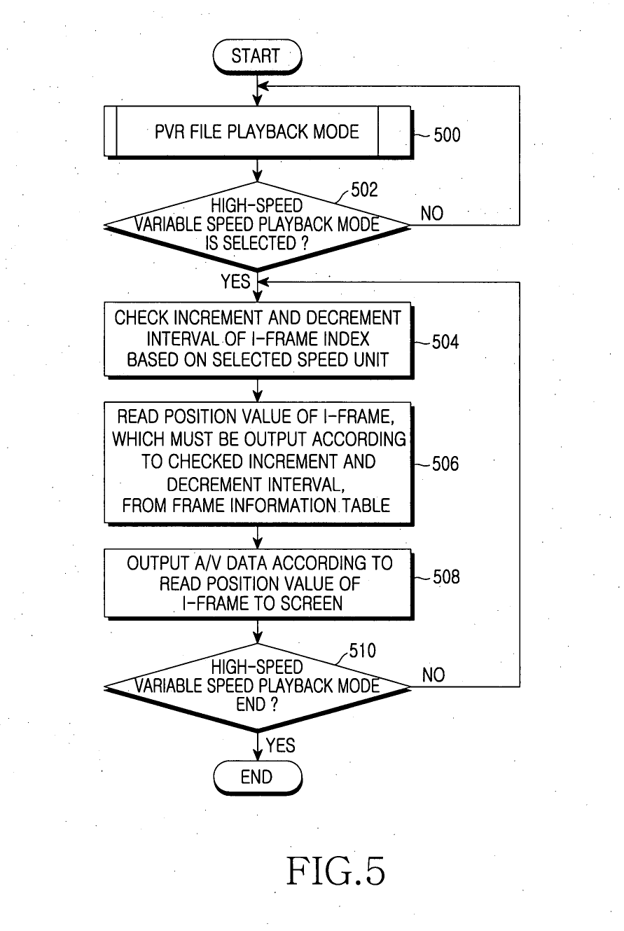

Hereinafter, a process for executing the high-speed variable speed playback mode according to speeds selected by a user when the reproduction of recorded digital broadcasting is requested by the user when the frame information table for execution of the high-speed variable speed playback mode is stored in advance will be described with reference to FIG. 5.

In step 500, the playback mode of a stored digital broadcasting file is executed at a user's request. In step 502, the controller 200 determines if a high-speed variable speed playback mode is selected. If the high-speed variable speed playback mode is selected, the controller 200 checks a speed unit selected when the high-speed variable speed playback mode is selected, and checks an increment and decrement interval of an I-frame index based on the selected speed unit, in step 504. Herein, the increment and decrement interval is stored in the storage unit 212 in advance as described in regard to FIG. 3.

In step 506, the controller 200 reads the position value of the I-frame, which must be output according to the checked increment and decrement interval, from the frame information table. In step 508, the controller 200 reads A/V data from the storage unit 212 according to the read position value of the I-frame, and displays the read A/V data on a screen. Herein, the controller 200 stores the frame information table generated when broadcasting streams are recorded in the storage unit 212, shifts the frame information table stored in the storage unit 212 to the memory unit 215 when the stored broadcasting streams are reproduced, and reads corresponding A/V data utilizing the position information of the frame information table stored in the memory unit 215.

In step 510, the controller 200 determines if a request for ending the high-speed variable speed playback mode exists. If the request exists, the process ends. Otherwise, steps 504, 506, 508 and 510 are repeated.

According to the present invention as described above, a frame information table including a position information value of an I-frame is stored in advance when digital broadcasting streams are recorded, and frames are scanned utilizing the position information value in the frame information table when a variable speed playback mode is executed, so that the scanned frames can be stably provided to a decoder regardless of speeds.

According to the present invention as described above, a frame information table including a position information value of an I-frame is stored in advance when digital broadcasting streams are recorded, so that desired frame information can be retrieved simply and easily. In this way, a variable speed playback mode can be executed regardless of speeds. In addition, S/W interference is considerably reduced, the performance of a decoder is maximally utilized, and more many frames are decoded and displayed within unit time when a high-speed variable speed playback mode is executed, so that it is possible to accomplish the variable speed playback mode having improved output image quality.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An apparatus for variable speed playback of digital broadcasting streams, the apparatus comprising:
a digital broadcasting reception unit for receiving digital broadcasting streams;
a demultiplexer for demultiplexing the received digital broadcasting streams, thereby dividing audio/video data from catalog information;
a frame information extractor for extracting position information of a specific frame from the catalog information;
a storage unit for storing a frame information table including the audio/video data and the extracted position information of the specific frame; and
a controller for extracting the position information of the specific frame through the frame information extractor according to a digital broadcasting data record request, and storing the frame information table in the storage unit.

2. The apparatus as claimed in claim 1, wherein the specific frame is an I-frame for quickly retrieving desired frame information when a variable speed playback mode is executed.

3. The apparatus as claimed in claim 2, wherein the position information of the specific frame includes start and end position values of each I-frame in the digital broadcasting streams.

4. The apparatus as claimed in claim 2, wherein the frame information table is formed by extracting only start and end positions of said each I-frame, adding indices to said each I-frame, and mapping start and end position values to said each I-frame having the added indices.

5. The apparatus as claimed in claim 1, wherein the storage unit stores increment and decrement interval information of an I-frame index according to speed units.

6. The apparatus as claimed in claim 5, wherein, if a high-speed variable speed playback mode request exists, the controller checks the position information of the specific frame in the frame information table according to a selected speed unit, reads audio/video data corresponding to a position of the specific frame, and outputs the audio/video data to a screen.

7. The apparatus as claimed in claim 6, wherein, if the high-speed variable speed playback mode request exists, the controller checks the selected speed unit, checks the increment and decrement interval of the I-frame index according to the selected speed unit, reads audio/video data stored in a predetermined position of the storage unit according to position values of the I-frame which are output based on the checked increment and decrement interval, and outputs the audio/video data to the screen.

8. A method for variable speed playback of digital broadcasting streams, the method comprising the steps of:
demultiplexing received digital broadcasting streams according to a digital broadcasting data record request, thereby dividing audio/video data from catalog information;
extracting position information of a specific frame from the catalog information; and
storing a frame information table including the audio/video data and the extracted position information of the specific frame.

9. The method as claimed in claim 8, wherein the specific frame is an I-frame for quickly retrieving desired frame information when a variable speed playback mode is executed.

10. The method as claimed in claim 9, wherein the position information of the specific frame includes start and end position values of each I-frame in the digital broadcasting streams.

11. The method as claimed in claim 9, wherein the frame information table is formed by extracting only start and end positions of said each I-frame, adding indices to said each I-frame, and mapping start and end position values to said each I-frame having the added indices.

12. The method as claimed in claim 8, further comprising storing increment and decrement interval information of an I-frame index according to speed units.

13. The method as claimed in claim 12, further comprising:
if a high-speed variable speed playback mode request exists, checking the position information of the specific frame in the frame information table according to a selected speed unit; and
reading audio/video data corresponding to a position of the specific frame, and outputting the audio/video data to a screen.

14. The method as claimed in claim 13, wherein the checking step comprises:
if the high-speed variable speed playback mode request exists, checking the selected speed unit; and
checking the increment and decrement interval of the I-frame index according to the selected speed unit.

15. The method as claimed in claim 14, wherein the reading step corresponds to reading audio/video data stored in a corresponding position according to position values of the I-frame which must be output based on the checked increment and decrement interval, and outputting the audio/video data to the screen.
